(19) United States
(12) Patent Application Publication
(10) Pub. No.: US 2003/0199810 A1
(43) Pub. Date: Oct. 23, 2003

(54) Methods and apparatuses for forming microprojection arrays

(76) Inventors: Joseph Creagan Trautman, Sunnyvale, CA (US); Cedric Thomas Wright, Santa Clara, CA (US); Richard Lamar Keenan, Fremont, CA (US); Keith T. Chan, Sunnyvale, CA (US)

Correspondence Address: ALZA CORPORATION, P O BOX 7210, INTELLECTUAL PROPERTY DEPARTMENT, MOUNTAIN VIEW, CA, 940397210

(21) Appl. No.: 10/305,641

(22) Filed: Nov. 27, 2002

Related U.S. Application Data
(60) Provisional application No. 60/336,083, filed on Nov. 30, 2001.

(51) Int. Cl. B29C 59/02

(52) U.S. Cl. 604/46; 606/185; 264/293

(57) ABSTRACT

A method for producing a device for piercing a body surface is disclosed. A sheet (200) is provided having opposite first and second faces. A plurality of microprojections (304) and openings (302) are formed through the first and second faces of the sheet (200). The first face of the sheet (200) is positioned adjacent a die (402) having a plurality of cavities (404) corresponding to the plurality of microprojections (304) of the sheet (200) in such a way that each of the microprojections (304) of the sheet (200) is positioned adjacent a corresponding cavity (404) of the die (402). An elastomeric material (410) is then forced against a second face of the sheet (200) and into the cavities (404) of the die (402) to deflect the microprojections (304) of the sheet (200) into the cavities (404) of the die (402). To aid bending of the microprojection (304) along its base (904), embodiments of the device may include a hole (902) through the microprojection (304), a groove (1202) in one face of the microprojection (304), or a notch (1104) in a side edge of the microprojection (304). In further embodiments, one sheet (200a) may be stacked with another sheet (200b) so that the openings (302a, 302b) of the sheets (200a, 200b) forming the device (1400) are generally in alignment with the opening of a top sheet (200a) of the stack with the microprojections (304b) of the sheets (200b) beneath the top sheet (200a) outwardly extending through the opening (302a) of the top sheet (200a) in the stack.

### TECHNICAL FIELD

The present invention relates to transdermal agent delivery and sampling. More particularly, this invention relates to the formation of microprojections such as skin-piercing microprojections for use in devices such as transdermal agent delivery and sampling devices.

### BACKGROUND ART

Interest in the percutaneous or transdermal delivery of peptides and proteins to the human body continues to grow with the increasing number of medically useful peptides and proteins becoming available in large quantities and pure form. The transdermal delivery of peptides and proteins still faces significant problems. In many instances, the rate of delivery or flux of polypeptides through the skin is insufficient to produce a desired therapeutic effect due to the binding of the polypeptides to the skin. In addition, polypeptides and proteins are easily degraded during and after penetration into the skin, prior to reaching target cells. Likewise, the passive flux of water soluble small molecules such as salts is limited.

There have been many attempts to enhance transdermal flux by mechanically puncturing the skin prior to transdermal drug delivery. See for example U.S. Pat. No. 5,279,544 issued to Gross et al., U.S. Pat. No. 5,250,023 issued to Lee et al., and U.S. Pat. No. 3,964,482 issued to Gerstel et al. These devices utilize tubular or cylindrical structures generally, although Gerstel does disclose the use of other shapes, to pierce the outer layer of the skin. Each of these devices provide manufacturing challenges, resistance to easy penetration of the skin, and/or undesirable irritation of the skin.

In the past, dies with metal pins have been utilized to bend microprojections into an orientation suitable for piercing skin. Such pins have to be fabricated and positioned with great precision thereby increasing the cost and time it takes to build such a die. Such dies are also unsuitable for the mass production of devices utilizing such microprojections.

### DISCLOSURE OF INVENTION

A method for producing a device for piercing a body surface is disclosed. A sheet is provided having opposite first and second faces. A plurality of microprojections and openings are formed through the first and second faces of the sheet. The first face of the sheet is positioned adjacent a die having a plurality of cavities corresponding to the plurality of microprojections of the sheet in such a way that each of the microprojections of the sheet is positioned adjacent a corresponding cavity of the die. An elastomeric material is then forced against a second face of the sheet and into the cavities of the die to deflect the microprojections of the sheet into the cavities of the die.

The device for piercing a body surface may comprise a sheet having an opening therethrough and a microprojection located along a periphery of the opening. In one embodiment, the microprojection may have a hole therethrough positioned at a base of the microprojection which is located adjacent the periphery of the opening. In another embodiment, the microprojection may have a groove in one face of the microprojection with the groove extending along a base of the microprojection. In a further embodiment, the microprojection may have a side edge outwardly extending from the periphery of the opening and a notch in the side edge positioned adjacent a base of the microprojection.

In embodiments of the present invention, a stacked device for piercing a body surface may be formed. In such an embodiment, the stacked device comprises a stack of sheets with each sheet having an opening therethrough and one or more microprojections located along a periphery of the opening and outwardly extending from the respective sheet. The openings of the sheets in the stack are generally in alignment with the opening of a top sheet of the stack with the microprojections of the sheets beneath the top sheet outwardly extending through the opening of the top sheet in the stack.

### BRIEF DESCRIPTION OF THE DRAWINGS

FIG. 1 is a plan view of a sheet in which one or more microprojection arrays are made in accordance with an embodiment of the present invention;

FIG. 2 is an enlarged plan view of a microprojection array in accordance with an embodiment of the present invention;

FIG. 3 is a cross sectional view of an assembly for bending microprojections in accordance with an embodiment of the present invention;

FIG. 4 is a cross sectional view of the assembly for bending microprojections after application of a microprojection bending force;

FIG. 5 is an enlarged cross sectional view of a single microprojection and a single cavity of a microprojection forming assembly prior to force being applied to the assembly in accordance with an embodiment of the present invention;

FIG. 6 is an enlarged cross sectional view of the single microprojection and single cavity of the microprojection forming assembly shown in FIG. 5 as a microprojection bending force is applied to the assembly in accordance with an embodiment of the present invention;

FIG. 7 is a diagram of components of an illustrative microprojection forming assembly in accordance with an embodiment of the present invention;

FIG. 8 is a plan view of an illustrative microprojection having a hole for aiding bending of the microprojection in accordance with an embodiment of the present invention;

FIG. 9 is a plan view of another illustrative microprojection having a hole for aiding bending of the microprojection in accordance with an embodiment of the present invention;

FIG. 10 is a plan view of a microprojection having a notch for aiding bending of the microprojection in accordance with an embodiment of the present invention;

FIG. 11 is a plan view of a microprojection having a groove for aiding bending of the microprojection in accordance with an embodiment of the present invention;

FIG. 12 is a cross sectional view of the grooved microprojection of FIG. 11 taken along line XII-XII;

FIG. 13 is a perspective view of a stacked microprojection array in accordance with an embodiment of the present invention;

FIG. 14 is an exploded perspective view of a stacked microprojection array in accordance with an embodiment of the present invention; and

FIG. 15 is an enlarged cross sectional view of another microprojection forming assembly of the present invention.

### DETAILED DESCRIPTION

The present invention provides reproducible, high volume production, low-cost methods and apparatuses for forming microprojection arrays suitable for use in skin piercing devices such as transdermal delivery and sampling devices.

In one embodiment of the invention, a method is provided for producing a device for piercing a body surface such as one or more skin layers of a body including, for example, the stratum corneum. A sheet of a ductile and/or bendable material is provided having opposite first and second faces. A plurality of microprojections and openings through the first and second faces of the sheet are formed by etching or by punching. The first face of the sheet is positioned adjacent a die having a plurality of cavities corresponding to the plurality of microprojections of the sheet so that each of the microprojections of the sheet is positioned adjacent (i.e., over) a corresponding cavity of the die. An elastomeric material is then forced against the second face of the sheet and into the cavities of the die to deflect the microprojections of the sheet into the cavities of the die with each microprojection being bent into its associated adjacent cavity so that the microprojections outwardly extend from the sheet. The method, preferably also includes removing at least a portion of the force against the elastomeric material in order to retract the elastomeric material from the cavities of the die, leaving the now bent microprojections extending into the cavities of the die.

The microprojections and openings through the first and second faces of the sheet are preferably formed utilizing an etching technique such as photo-etching one or both faces of the sheet. The elastomeric material may comprise polyurethane or silicone. The forcing of the elastomeric material against the second face of the sheet is preferably achieved by positioning a bore of a block adjacent the second face of the sheet so that at least a portion of the plurality of microprojections and openings of the sheet are positioned inside an outer perimeter of the bore of the block. The elastomeric material may then be deposited in the bore of the block. Next, a piston may be inserted into the bore of the block to force the elastomeric material against the second face of the sheet and into the cavities of the die such that the microprojections of the sheet are deflected into the cavities of the die as the elastomeric material enters the cavities.

In one embodiment of the method, the microprojections may be deflected in such a manner that the axes of the microprojections are substantially parallel and the axes form an angle relative to the plane of the sheet. The elastomeric material is forced against the second face of the sheet with a force sufficient to deflect at least a portion of the microprojections of the sheet typically at least 45 degrees from a plane of the sheet. More preferably, the elastomeric material is forced against the second face of the sheet with a force sufficient to deflect at least a portion of the microprojections of the sheet at least 60 degrees from a plane of the sheet. Most preferably, the elastomeric material is forced against the second face of the sheet with a force sufficient to deflect at least a portion of the microprojections of the sheet about 90 degrees from a plane of the sheet.

In one embodiment of the present invention, the cavities of the die may each have a depth greater than a length of the associated adjacent microprojection of the sheet. In another embodiment, an outer perimeter of each cavity of the die is inside an outer perimeter of an adjacent opening of the sheet so that the outer perimeters of the openings are positioned adjacent the face of the die having the cavities and do not extend over the cavities of the die. As an option, each of the microprojections of the sheet may have a base positioned adjacent an inwardly extending lip of the corresponding adjacent cavity of the die. In such an embodiment, the base of each microprojection may be bent against the lip of the corresponding adjacent cavity of the die during the deflection of the microprojections into the cavities. Further, the base of each microprojection may also be bent into a shape corresponding to a contour of the lip of the corresponding cavity of the die.

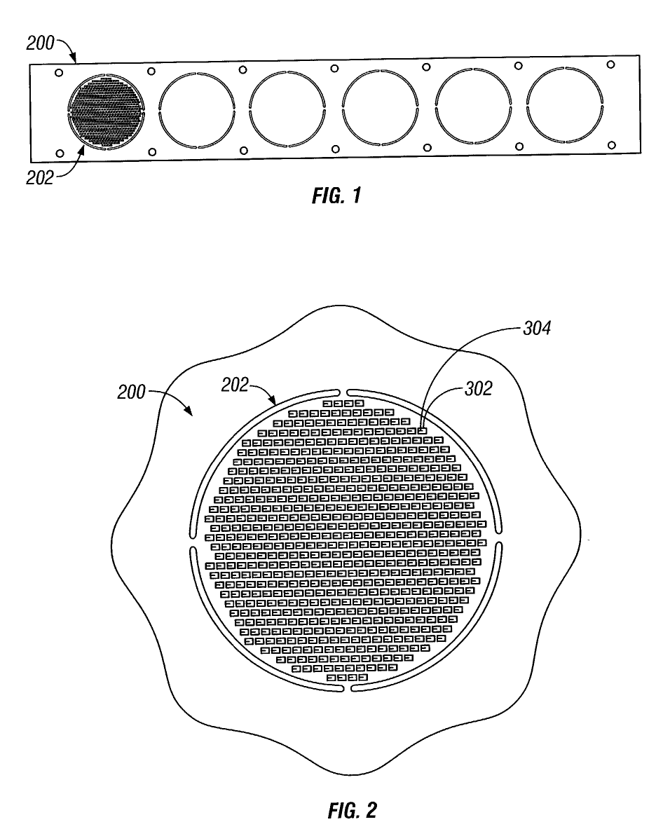

FIG. 1 shows an illustrative sheet 200 in which a microprojection array 202 has been fabricated. In closer detail, as shown in FIG. 2, the microprojection array 202 of the sheet 200 comprises a plurality of openings 302 through the sheet. Extending from the periphery of each opening is a microprojection 304. At the time of the forming of the array 202, the microprojections 304 generally lie in a common plane with the sheet 200. The microprojections 304 may be bent out of this plane to outwardly extend from the sheet 200 utilizing a bending technique such as the method described earlier herein.

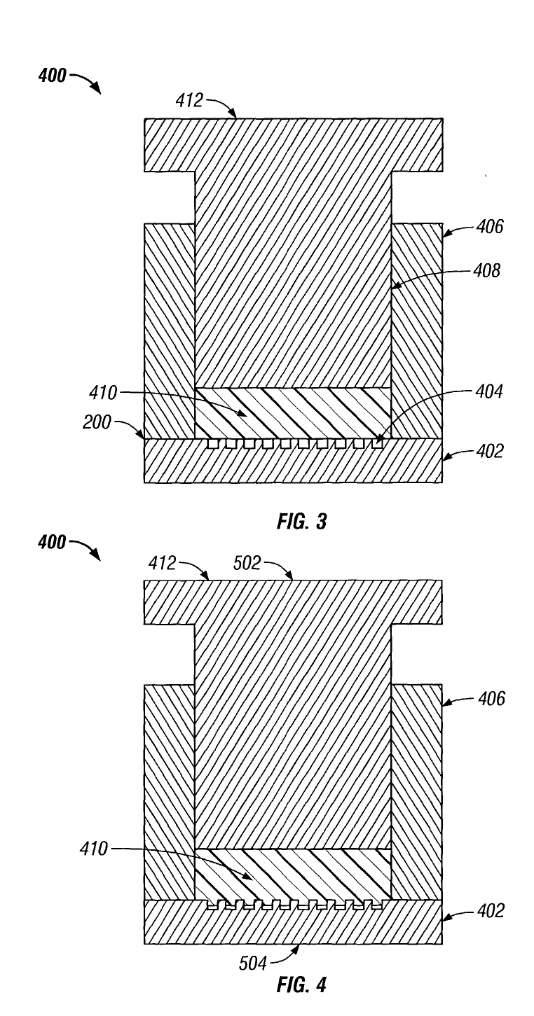

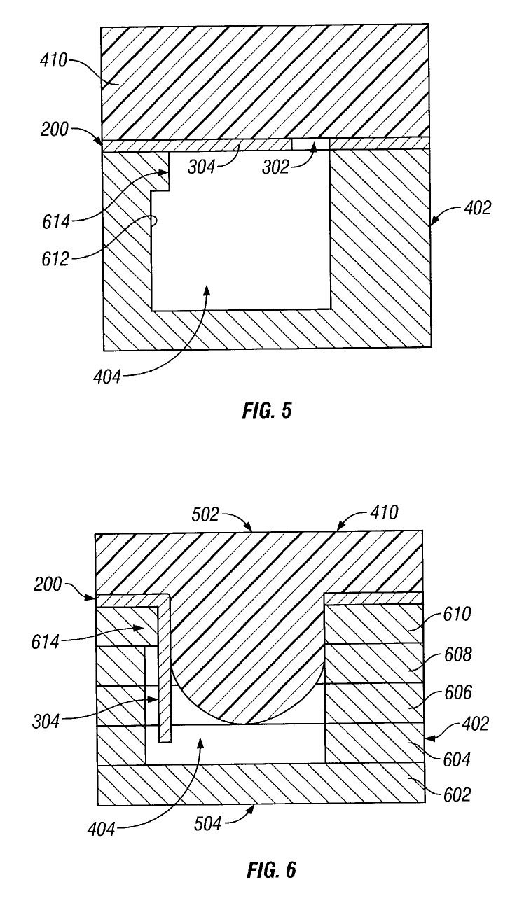

FIG. 3 is a cross sectional view of a microprojection forming assembly 400 for bending microprojections in accordance with the method of the present invention. The microprojection forming assembly 400 includes a die 402 having a plurality of cavities 404 in one face thereof. In one embodiment, the number of cavities 404 provided in the die 402 may correspond to the number of microprojections in the array of the sheet that are to be bent out of the plane of the sheet so that each microprojection has a cavity associated therewith. The sheet 200 with the microprojection array 202 formed thereon is positioned adjacent the die 402 so that each of the microprojections 304 is positioned over a corresponding cavity 404 of the die 402 as best shown in FIG. 5. Microprojection forming assembly 400 also includes a block 406 having a bore 408. One end of the block 406 is positioned adjacent the face of the die with the cavities so that the cavities 404 are located inside the periphery of the bore 408.

An elastomeric material 410 is deposited in the bore 408 and a piston 412 is inserted into the bore so that the elastomeric material 410 is positioned in the bore between the piston 412 and the cavities 404 of the die. As shown in FIG. 4, when a force 502, 504 is applied in the direction of one or both arrows against the piston 412 and/or the die 402 to bring the piston closer to the die, the elastomeric material 410 is deformed and forced into the cavities of the die located inside the periphery of the bore of the block 406. FIG. 5 is an enlarged cross sectional view of a single microprojection 304 and a single cavity 404 of the microprojection forming assembly prior to the deflecting force being applied to the elastic material 410. The block 406 is then positioned adjacent the sheet 200 so that the sheet 200 is interposed between the block 406 and the die 402 with the bore 408 located over the microprojection array 202. The elastomeric material 410 is then deposited in the bore 408 so that the microprojection array 202 is positioned between the elastomeric material 410 and the cavities 404 of the die 402. In one embodiment, an outer perimeter of the cavity 404 may be inside or flush with (as illustrated in FIG. 5) an outer perimeter of the opening 302 associated with that particular microprojection so that the outer perimeter of the opening 302 is positioned adjacent the face of the die 402 having the cavities 404 and do not extend over the cavities 404 of the die 402.

The die 402 may comprise an integral layer of material (e.g., metal, plastic or ceramic) with cut out cavities 404 as shown in FIG. 5 or may comprise a base plate 602 with one or more forming plates 604, 606, 608, 610 stacked thereon as shown in FIG. 6. Each of the forming plates has a plurality of openings (e.g., opening 612) therethrough that form the cavities 404 of the die 402 when the forming plates are stacked together and properly aligned. By forming the die using the base plate and forming plates, the depths of the cavities of the die may be adjusted as desired. In one embodiment, the cavities of the die may be formed so that each cavity has a depth greater than a length of the associated adjacent microprojection of the sheet so that when the microprojection 304 is bent into the cavity 404, the tip of the microprojection 304 is not bent or deformed by hitting the bottom surface of the cavity 404.

As an option, each cavity may have a lip 614 extending into the cavity. In one embodiment as illustrated in FIGS. 5 and 6, the lip may be provided in the top most forming plate of the stack of forming plates to aid in the bending of the microprojection at a desired location and/or angle. In use, each microprojection 304 may have its base positioned adjacent the lip 614 of its associated cavity 404. In such an embodiment, the base of each microprojection 304 is bent against the lip 614 of the corresponding adjacent cavity of the die during the deflection of the microprojections into the cavities. Further, the base of each microprojection may also be bent into a shape corresponding to a contour of the lip of the corresponding cavity of the die. For example, if the lip has a vertical outer profile (as shown in FIGS. 5 and 6), the microprojection may be bent at a right angle to the sheet. As another example, if the lip has an outer profile extending at an acute angle to the plane of the sheet, the microprojection may be bent to an angle conforming with the acute angle of the lip's outer profile. Similarly, of the lip's outer profile is concave (or another shape), the microprojection may be bent along a concave bend corresponding to the concave or other shape of the lip. When bending microprojections formed of metals and plastics, there is a tendency for the microprojection to spring back once the bending force is removed. The lip 614 allows (e.g., in the case of microprojections which are to extend perpendicularly from the sheet) the microprojection to be bent slightly beyond 90 degrees so that the microprojection springs back to 90 degrees upon removal of the bending force.

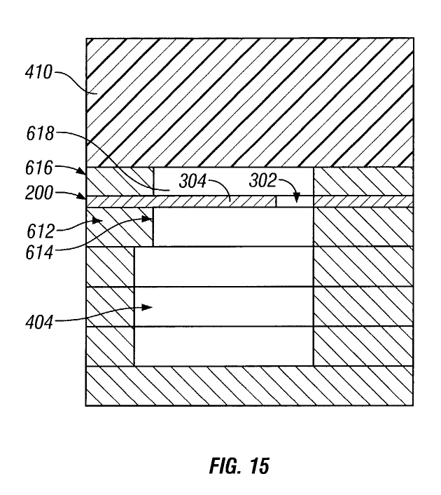

Optionally, a cover plate 616 is positioned over the sheet 200 so that the sheet 200 is clamped between the top surface of die 402 and the bottom surface of the cover plate 616 as shown in FIG. 15. The cover plate 616 has openings 618 which correspond in size and shape to the openings to the cavities 404 in die 402. The cover plate 616 makes the microprojection bend angle more consistent; both more consistent between individual microprojections within a single microprojection array as well as more consistent from one microprojection array to the next. The cover plate 616 also increases the useful life of the elastomer 410 and decreases sheet 200 deformation during the microprojection bending step.

FIG. 6 is an enlarged cross sectional view of the single microprojection 304 and single cavity 404 of FIG. 5 as a microprojection bending force is applied in the direction of arrows 502, 504 to the microprojection forming assembly 400. In particular, as the force is applied, the elastomeric material 410 is forced through the opening 302 of the sheet 200 and into the cavity 404 of the die 402. As the elastomeric material 410 is forced into the cavity 404, it deflects the microprojection 304 into the cavity and bends the microprojection along its base at either the periphery of the cavity or the outer edge of the lip 614 (if provided). When the force is removed or reduced, the elastomeric material relaxes and exits the cavity of the die leaving the now bent microprojection extending into the cavity.

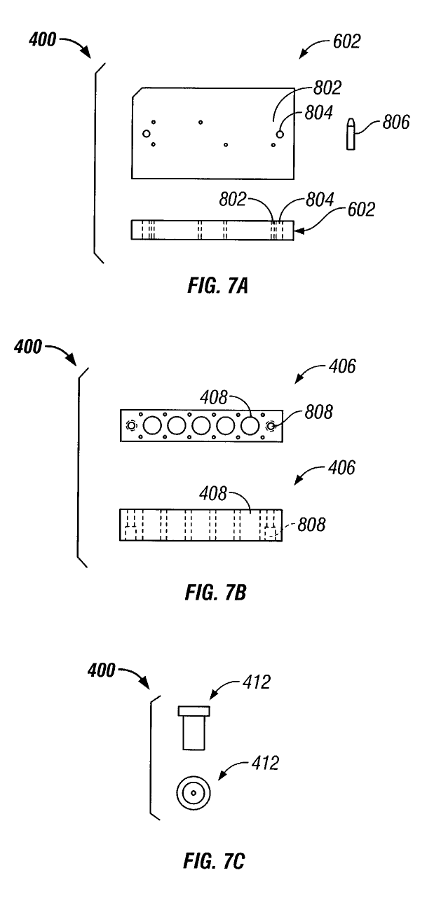

FIG. 7 shows side and plan views of some of the components of an illustrative microprojection forming assembly 400 including the base plate 602, the block 406, and the piston 412. In this illustrative embodiment, the base plate 602 may include a plurality of protrusions 802 for insertion into corresponding holes in the bottom most forming plate (e.g., forming plate 604) of the stack of forming plates, and may also include one or more sockets 804 for receiving a guide pin 806 which, in turn may be extended through aligned holes in the stack of forming plates to hold the forming plates in their proper alignment and thereby maintain the proper form of the cavities of the die. The block 408 may include one or more bores 408 each for receiving an associated piston 412 therein. The block may also include holes 808 for receiving the guide pin(s) 806 to hold the block in its proper alignment with the die when positioned over the cavities of the die and the microprojection array(s) of the sheet.

The elastomeric material should have appropriate hardness to deform and flow into cavities 404, and thereby deflect the microprojections 304 into the cavities 404 when pressure is applied. To some degree, the appropriate hardness and flow properties of the elastomeric material will vary depending upon the size of the openings 302 in the sheet 200, as well as the material (e.g., metal or plastic) and the thickness of sheet 200. For titanium sheets having a thickness of about 10 to 50 microns, elastomers having a durometer hardness of about 20A to about 100A have been found to be useful. Durometer hardness can be determined using ASTM Test Method D2240-00 “Standard Test Method for Rubber Property—Durometer Hardness”. Elastomeric materials such as silicone rubber, butyl rubber and polyurethane can be used. One particularly preferred material is a polyurethane having a durometer hardness of 70A sold by Esco Plastics Company of Houston, Tex. Other suitable elastomeric materials include, but not necessarily limited to, for example, room temperature volcanized silicone mold rubber (known as blue silicone) made by Circle K Products of Temecula, Calif.; and white silicone sold by Dow Corning under the tradename Silastic E RTV. In one embodiment, the outer perimeter of the elastomeric material may match the perimeter of the bore. For example, if the bore is cylindrical in shape, then the elastomeric material may be disc-shaped for aiding depositing of the elastomeric material in the bore.

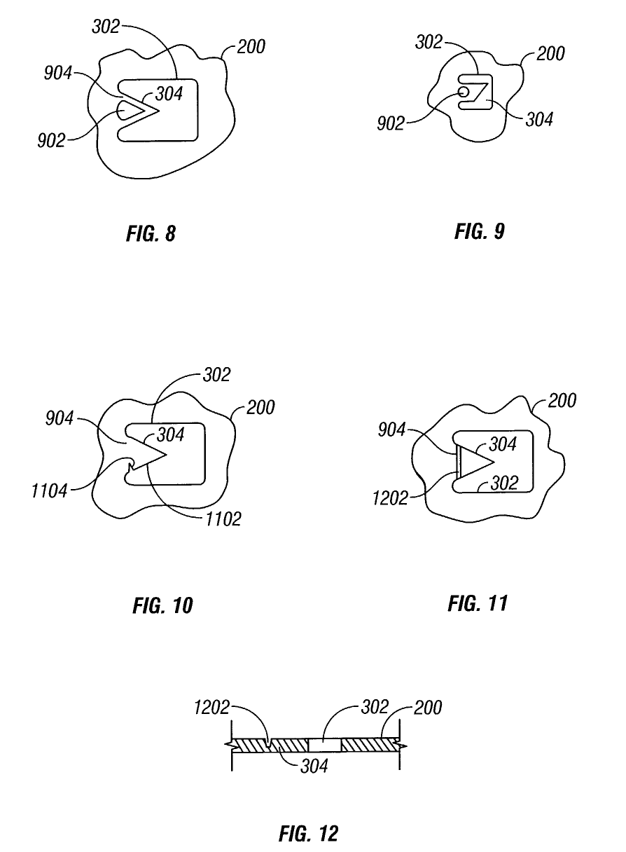

With reference to FIGS. 8 through 12, microprojections may be modified in a variety of ways to aid in the bending of the microprojections especially when bending the microprojections utilizing the method described herein. These modifications help to decrease the amount of force required to bend the microprojections. These modifications may also help to control the location of the bend by decreasing the stiffness of the microprojection and may further aid in the bending of the microprojections into a perpendicular orientation with respect to the sheet.

One such modification is illustrated in FIG. 8, a microprojection 304 may be have a hole 902 therethrough for aiding proper (or desired) bending of the microprojection along its base. As previously mentioned, the body surface piercing device may comprise a sheet of ductile and/or bendable material having an array of one or more microprojections with each microprojection 304 located along a periphery of an associated opening 302 through the sheet. Each microprojection 304 has a base 904 (located adjacent the periphery of the opening) along which the microprojection may be bent during deflection of the microprojection so that the microprojection outwardly extends from its sheet. As shown in FIG. 8, in one embodiment, the base of a microprojection may have a hole 902 for aiding bending of the microprojection along the base. As a further option, the hole 902 may be positioned on the microprojection so that it is generally centered along the base of the microprojection as illustrated in FIG. 8. The hole 902 may be any suitable shape for the microprojection including for example, teardrop shaped as shown in FIG. 8 or circular as shown in FIG. 9. Similarly, it should be understood, that such a hole is suitable in any suitably shaped microprojection including the illustrative microprojection 304 in FIG. 9 that has a single pointed tip and an angled leading edge.

Other modifications of the microprojections to aid their bending are shown in FIGS. 10, 11, and 12. With reference to FIG. 10, in another embodiment of the present invention, the microprojection may have a side edge 1102 with a notch 1104 therein positioned adjacent the base of the microprojection 904 to aid the bending of the microprojection along the base. With reference to FIGS. 11 and 12, in a further embodiment, the base of the microprojection 304 may have a groove 1202 in one face of the microprojection that extends along the base 904 of the microprojection to aid the bending of the microprojection along the base.

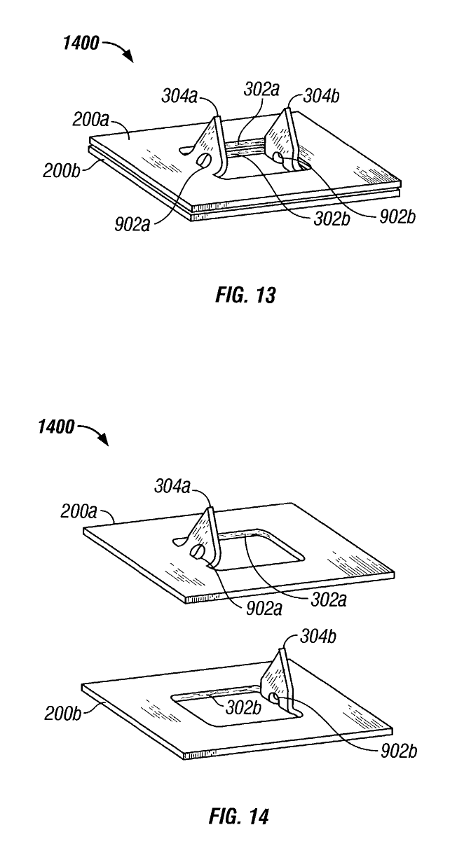

Turning to FIGS. 13 and 14, a device 1400 for piercing a body surface may be formed by stacking two or more microprojection arrays together. Typically, prior art microprojection arrays have been reaching a point of maximum density of microprojections/area. The number of microprojections that can be penetrated into the skin is limited to this density. Typically, in order to flux more drug into the skin, a larger area array may be necessary, which in turn, requires a larger patch and applicator system. By stacking one or more microprojection arrays as in the manner set forth in FIGS. 13 and 14, one can increase the number of microprojections in the same array area.

In closer detail, the device 1400 comprises a stack of sheets 202a, 202b with each sheet an array of microprojections comprising at least one opening 302a, 302b therethrough and one or more microprojections 304a, 304b located along a periphery of the respective opening and outwardly extending from the respective sheet.

As shown in FIG. 13, the sheets 200a, 200b are aligned with one another so that the openings 302a, 302b of the sheets in the stack are generally in alignment with the opening of the top sheet and so that the microprojection(s) 304b of the sheets beneath the top sheet 200a outwardly extend through the opening 302a of the top sheet in a generally common direction as the microprojection 304a of the top sheet. In one embodiment, at least one of the microprojections of at least one of the sheets in the stack may have a hole 902a, 902b therethrough positioned at a base of the respective microprojection located adjacent the periphery of the opening of the respective sheet. In a further embodiment, the microprojection(s) 304a of the top sheet 200a each may have a length less than each of the microprojections of the other sheets in the stack so that the tips of the microprojections extending from the stack generally lie in a common plane with the tip of the microprojection of the top sheet.

In yet another embodiment, the microprojections of the sheets may be spaced apart from each other. As illustrated in FIGS. 13 and 14, in an embodiment where the stack of sheets 1400 simply comprise two sheets, the sheets may be positioned adjacent one another so that peripheries of the openings of sheets are generally aligned with one another and the microprojection of one of the sheets extends through the opening of the other sheet. As an option, the microprojections of the sheets may be spaced apart from each other and, as a further option, positioned at opposite sides of the aligned openings of the sheets.

It will be appreciated by those working in the field that the present invention may be used in a variety of applications including a variety of drug delivery and sampling applications. For examples of such applications reference may be had to PCT Publication No. WO 97/48440 entitled, “DEVICE FOR ENHANCING TRANSDERMAL AGENT DELIVERY OR SAMPLING” by Michel J. Cormier et al., U.S. Pat. No. 6,230,051 B1 issued May 8, 2001 and entitled “DEVICE FOR ENHANCING TRANSDERMAL AGENT DELIVERY OR SAMPLING” by Michel J. Cormier et al., and U.S. Pat. No. 6,219,574 B1 issued Apr. 17, 2001 and entitled “DEVICE FOR ENHANCING TRANSDERMAL AGENT DELIVERY OR SAMPLING” by Michel J. Cormier et al., the disclosures of which are incorporated by reference herein in their entirety.

In particular, a microprojection array may be utilized in conjunction with percutaneous administration or sampling of an agent. The terms “substance”, “agent” and “drug” are used interchangeably herein and broadly include physiologically or pharmacologically active substances for producing a localized or systemic effect or effects in mammals including humans and primates, avians, valuable domestic household, sport or farm animals, or for administering to laboratory animals such as mice, rats, guinea pigs, and the like. These terms also include substances such as glucose, body electrolytes, alcohol, licit substances, pharmaceuticals, illicit drugs, etc. that can be sampled through the skin. The major barrier properties of the skin, such as resistance to drug penetration, reside with the outermost layer (i.e., stratum corneum). The inner division of the epidermis generally comprises three layers commonly identified as stratum granulosum, stratum malpighii, and stratum germinativum. Once a drug penetrates below the stratum corneum, there is substantially less resistance to permeation through the stratum granulosum, stratum malpighii, and stratum germinativum. The device of the present invention may be used to form microslits in the stratum corneum and produce a percolation area in the skin for improved transdermal delivery or sampling of an agent.

The microprojections may comprise a plurality of microscopic cutting elements extending downward from one surface of a sheet. The microprojections may be sized and shaped to penetrate the stratum corneum of the epidermis when pressure is applied to the device. The microprojections form microslits in a body surface to increase the administration of or sampling of a substance through the body surface. The term “body surface” as used herein refers generally to the skin of an animal or human.

In the case of therapeutic agent (e.g., drug) delivery, the drug may be released from a drug-containing reservoir through the openings in the sheet and passed through microslits formed by the microprojections cutting through the stratum corneum. The drug migrates down the outer surfaces of the microprojections and through the stratum corneum to achieve local or systemic therapy. Alternatively, the agent may be coated, e.g., in a dry coating applied directly on the surfaces of the microprojections. In the case of agent (e.g., body analyte) sampling, the analyte migrates from the body through the microslits in the stratum corneum which are cut by the microprojections.

The pattern for any of the microprojection array devices of the present invention may be produced with a photo-etching process. For example, reference may be had to WO 97/48440 of which any of the disclosed methods can be used to produce the microprojection arrays of the present invention. In particular, a thin sheet or plate of metal such as stainless steel or titanium may be etched photo-lithographically with patterns containing microprojection-like structures (i.e., the microprojections).

While the microprojections disclosed in the Figures are generally bent at an angle of about 90 degrees to the surface of the sheet 200, those skilled in the art will appreciate that other bend angles may be achieved using the apparatus and methods disclosed herein. In general, the microprojections can be disposed at any angle forward or backward from the perpendicular position that will facilitate penetration of and attachment to the stratum corneum.

The sheet and microprojections can be made from materials that have sufficient strength and capability of being bent to produce microprojections, such as metals and metal alloys. Examples of metals and metal alloys include but are not limited to platinum, stainless steel, iron, steel, tin, zinc, copper, aluminum, germanium, nickel, zirconium, titanium and titanium alloys consisting of nickel, molybdenum and chromium, metals plated with nickel, gold, rhodium, iridium, titanium, platinum, and the like. Other bendable materials such as bendable hard plastics can also be used.

This invention has utility in connection with the delivery of drugs within any of the broad class of drugs normally delivered through body surfaces and membranes, including skin. In general, this includes drugs in all of the major therapeutic areas.

The present invention has particular utility in the delivery of peptides, polypeptides, proteins, nucleotidic drugs, antigenic agents, vaccines, and other such species through body surfaces such as skin. These substances typically have a molecular weight of at least about 300 Daltons, and more typically have a molecular weight of at least about 300 to 40,000 Daltons. Specific examples of peptides and proteins in this size range include, without limitation, LHRH, LHRH analogs such as goserelin, buserelin, gonadorelin, napharelin and leuprolide, GHRH, GHRF, insulin, insultropin, calcitonin, octreotide, endorphin, TRH, NT-36 (chemical name: N-[[(s)-4-oxo-2-azetidinyl]carbonyl]-L-histidyl-L-prolinamide),liprecin, pituitary hormones (e.g., HGH, HMG, desmopressin acetate, etc), follicle luteoids, aANF, growth factors such as growth factor releasing factor (GFRF), bMSH, GH, somatostatin, bradykinin, somatotropin, platelet-derived growth factor, asparaginase, bleomycin sulfate, chymopapain, cholecystokinin, chorionic gonadotropin, corticotropin (ACTH), erythropoietin, epoprostenol (platelet aggregation inhibitor), glucagon, HCG, hirulog, hyaluronidase, interferon, interleukins, menotropins (urofollitropin (FSH) and LH), oxytocin, streptokinase, tissue plasminogen activator, urokinase, vasopressin, desmopressin, ACTH analogs, ANP, ANP clearance inhibitors, angiotensin II antagonists, antidiuretic hormone agonists, bradykinin antagonists, ceredase, CSI's, calcitonin gene related peptide (CGRP), enkephalins, FAB fragments, IgE peptide suppressors, IGF-1, neurotrophic factors, colony stimulating factors, parathyroid hormone and agonists, parathyroid hormone antagonists, prostaglandin antagonists, pentigetide, protein C, protein S, renin inhibitors, thymosin alpha-1, thrombolytics, TNF, vaccines, vasopressin antagonists analogs, alpha-1 antitrypsin (recombinant), and TGF-beta. Suitable antigenic agents which can be used in the present invention include antigens in the form of proteins, polysaccharides, oligosaccharides, lipoproteins, weakened or killed viruses such as cytomegalo virus, hepatitis B virus, hepatitis C virus, human papillomavirus, rubella virus, and varicella zoster, weakened or killed bacteria such as bordetella pertussis, costridium tetani, corynebacterium diptheriae, group A streptococcus, legionella pneumophila, neisseria meningitdis, pseudomonas aeruginosa, streptococcus pneumoniae, treponema pallidum, and vibrio cholerae and mixtures thereof. A number of commercially available vaccines which contain antigenic agents may also have utility with the present invention and include flu vaccines, Lyme disease vaccine, rabies vaccine, measles vaccine, mumps vaccine, chicken pox vaccine, small pox vaccine, hepatitus vaccine, pertussis vaccine, and diptheria vaccine.

While the invention has been described in conjunction with the preferred specific embodiments thereof, it is to be understood that the foregoing description is intended to illustrate and not limit the scope of the invention. Other aspects, advantages and modifications within the scope of the invention will be apparent to those skilled in the art to which the invention pertains.

What is claimed is:

1. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die.

2. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die;
forcing an elastomeric material against the second face of the sheet and against the microprojections formed therein; wherein the elastomeric material is forced into the cavities of the die causing the microprojections of the sheet to be bent into the cavities of the die; and
reducing the force on at least a portion of the elastomeric material thereby causing the retraction of at least a portion of the elastomeric material from the cavities of the die.

3. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
providing a block having a bore therethrough;
positioning the block adjacent the second face of the sheet so that at least a portion of the plurality of microprojections and openings of the sheet are positioned within the bore of the block;
providing a piston which is sized to fit within the bore of the block;
disposing an elastomeric material in the bore of the block; and
biasing the piston into the bore of the block to force the elastomeric material against the second face of the sheet and against the microprojections formed therein; wherein the elastomeric material is forced into the cavities of the die causing the microprojections of the sheet to be bent into the cavities of the die.

4. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
wherein the elastomeric material is biased against the second face of the sheet with a force sufficient to bend at least a portion of the microprojections of the sheet into the cavities of the die to an angle of at least 45 degrees from a plane of the sheet.

5. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
wherein the elastomeric material is biased against the second face of the sheet with a force sufficient to bend at least a portion of the microprojections of the sheet into the cavities of the die to an angle of at least 60 degrees from a plane of the sheet.

6. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
wherein the elastomeric material is biased against the second face of the sheet with a force sufficient to bend at least a portion of the microprojections of the sheet into the cavities of the die to an angle of at least 90 degrees from a plane of the sheet.

7. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
wherein the elastomeric material is biased against the second face of the sheet with a force sufficient to bend at least a portion of the microprojections of the sheet into the cavities of the die to an angle between about 1 degree to about 90 degrees relative to the a plane of the sheet and all of the microprojections are bent to substantially the same angle.

8. A method for producing a device for piercing a body surface, the method comprising the steps of:
providing a sheet having opposite first and second faces;
forming, by an etching process, a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die.

9. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet; wherein the cavities of the die each have a depth greater than a length of the associated corresponding microprojection of the sheet;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die.

10. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet; wherein the outer perimeter of each opening of the sheet is located inside of the outer perimeter of the adjacent cavity of the die;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die.

11. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die;
forcing an elastomeric material against the second face of the sheet and against the microprojections formed therein; the elastomeric material being forced into the cavities of the die causing the microprojections of the sheet to be bent into the cavities of the die; and
wherein each of the microprojections of the sheet has a base positioned adjacent an inwardly extending lip of the corresponding adjacent cavity of the die so that during the bending of the microprojections, the base of each microprojection is bent against the inwardly extending lip of the corresponding adjacent cavity of the die.

12. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die;
forcing an elastomeric material against the second face of the sheet and against the microprojections formed therein; the elastomeric material being forced into the cavities of the die causing the microprojections of the sheet to be bent into the cavities of the die; and
wherein each of the microprojections of the sheet has a base positioned adjacent an inwardly extending lip of the corresponding adjacent cavity of the die so that during the bending of the microprojections, the base of each microprojection is bent against the inwardly extending lip of the corresponding adjacent cavity of the die and each microprojection is bent into a shape corresponding to the contour of the inwardly extending lip of the corresponding cavity of the die.

13. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material, said elastomeric material being selected from the group consisting of silicone rubber, butyl rubber and polyurethane, against the second face of the sheet and against the microprojections formed therein; wherein the elastomeric material is forced into the cavities of the die causing the microprojections of the sheet to be bent into the cavities of the die.

14. A method for producing a device for piercing a body surface, the method comprising the steps of:
providing a sheet having opposite first and second faces;
forming a plurality of microprojections and openings through the first and the second faces of the sheet; each microprojection having a base;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die, the base of each microprojection having an opening to facilitate bending of the microprojection along the base.

15. A method for producing a device for piercing a body surface, the method comprising the steps of:
providing a sheet having opposite first and second faces;
forming a plurality of microprojections and openings through the first and the second faces of the sheet; each microprojection having a base;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die, the base of each microprojection having a groove to facilitate bending of the microprojection along the base.

16. A method for producing a device for piercing a body surface, the method comprising the steps of:
providing a sheet having opposite first and second faces;
forming a plurality of microprojections and openings through the first and the second faces of the sheet; each microprojection having a base;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die, the base of each microprojection having an a notch along at least one side of the microprojection to facilitate bending of the microprojection along the base.

17. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die;
providing a cover plate having a plurality of openings therethrough which correspond in size, shape and location to the plurality of cavities in the die;
placing the cover plate on the second face of the sheet; and
forcing an elastomeric material against the cover plate and against the microprojections formed in the sheet; wherein the elastomeric material is forced into the cavities of the die causing the microprojections of the sheet to be bent into the cavities of the die.

18. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
providing a block having a bore therethrough;
positioning the block adjacent the second face of the sheet so that at least a portion of the plurality of microprojections and openings of the sheet are positioned within the bore of the block;
providing a piston which is sized to fit within the bore of the block;
disposing an elastomeric material in the bore of the block; said elastomeric material shaped to fit within the bore; and
biasing the piston into the bore of the block to force the elastomeric material against the second face of the sheet and against the microprojections formed therein; wherein the elastomeric material is forced into the cavities of the die causing the microprojections of the sheet to be bent into the cavities of the die.

19. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
positioning the first face of the sheet against the die so that each of the microprojections of the sheet is positioned adjacent a corresponding cavity of the die; and
forcing an elastomeric material against the second face of the sheet and against the microprojections formed therein; said elastomeric material having a durometer hardness of 20A to about 100A as determined by the ASTM Test Method D2240-00, the elastomeric material being forced into the cavities of the die, causing the microprojections of the sheet to be bent into the cavities of the die.

20. A method for producing a device for piercing a body surface, the method comprising the steps of:
providing a sheet having opposite first and second faces;
forming a plurality of microprojections and openings through the first and the second faces of the sheet;
providing a die having a plurality of cavities corresponding to the plurality of microprojections of the sheet;
the die being comprised of a base plate and one or more forming plates; wherein each forming plate contains a plurality of openings therethrough and wherein the openings in each the forming plates are correspondingly located so that when the forming plates are aligned and disposed on the base plate, the openings also align and form said cavities;
positioning the first face of the sheet against the die so that each of the microprojections of the sheet is positioned adjacent a corresponding cavity of the die; and
forcing an elastomeric material against the second face of the sheet and against the microprojections formed therein; wherein the elastomeric material is forced into the cavities of the die causing the microprojections of the sheet to be bent into the cavities of the die.

21. A device for piercing a body surface, comprising:
a sheet having an opening therethrough and a microprojection located along a periphery of the opening; and
the microprojection having an opening therethrough positioned at a base of the microprojection, the base being located adjacent the periphery of the opening.

22. A device for piercing a body surface, comprising:
a sheet having an opening therethrough and an outwardly extending microprojection located along a periphery of the opening; and
the microprojection having an opening therethrough positioned at a base of the microprojection, the base being located adjacent the periphery of the opening.

23. A device for piercing a body surface, comprising:
a sheet having an opening therethrough and a microprojection located along a periphery of the opening; and
the microprojection having an opening therethrough positioned at a base of the microprojection, the opening being generally centered along an axis of the base, the base being located adjacent the periphery of the opening.

24. A device for piercing a body surface, comprising:
a sheet having an opening therethrough and one or more downwardly extending microprojections located along a periphery of the opening; and
one or more of the microprojections having a groove in one face of the microprojection, the groove extending along a base of the microprojection, the base being located adjacent the periphery of the opening.

25. A device for piercing a body surface, comprising:
a sheet having an opening therethrough and one ore more microprojections located along a periphery of the opening; and
the microprojection having a side edge outwardly extending from the periphery of the opening and a notch in the side edge positioned adjacent a base of the microprojection, the base being located adjacent the periphery of the opening.

26. A device for piercing a body surface, comprising:
a stack of sheets including a top sheet, each of the sheets having an opening therethrough and one or more microprojections located along a periphery of the opening and outwardly extending from the respective sheet; and
the openings of the sheets in the stack being generally in alignment with the opening of the top sheet and the microprojections of the sheets beneath the top sheet outwardly extending through the openings of the top sheet.

27. A device for piercing a body surface, comprising:
a stack of two sheets including a top sheet, each of the sheets having an opening therethrough and one or more microprojections located along a periphery of the opening and outwardly extending from the respective sheet; and
the openings of the sheets in the stack being generally in alignment with the opening of the top sheet and the microprojections of the sheets beneath the top sheet outwardly extending through the openings of the top sheet.

28. A device for piercing a body surface, comprising:
a stack of sheets including a top sheet, each of the sheets having an opening therethrough and one or more microprojections located along a periphery of the opening and outwardly extending from the respective sheet;
the openings of the sheets in the stack being generally in alignment with the opening of the top sheet and the microprojections of the sheets beneath the top sheet outwardly extending through the openings of the top sheet; and
wherein at least one of the microprojections of at least one of the sheets has a hole therethrough positioned at a base of the respective microprojection located adjacent the periphery of the opening of the respective sheet.

29. A device for piercing a body surface, comprising:
a stack of sheets including a top sheet, each of the sheets having an opening therethrough and one or more microprojections located along a periphery of the opening and outwardly extending from the respective sheet;
the openings of the sheets in the stack being generally in alignment with the opening of the top sheet and the microprojections of the sheets beneath the top sheet outwardly extending through the openings of the top sheet; and
wherein the one or more microprojections of the top sheet each have a length less than each of the one or more microprojections of the other sheets of the stack.

30. A device for piercing a body surface, comprising:
a stack of sheets including a top sheet, each of the sheets having an opening therethrough and one or more microprojections located along a periphery of the opening and outwardly extending from the respective sheet;
the openings of the sheets in the stack being generally in alignment with the opening of the top sheet and the microprojections of the sheets beneath the top sheet outwardly extending through the openings of the top sheet; and
wherein the microprojections of the sheets are spaced apart from each other.

31. A device for piercing a body surface, comprising:
a pair of sheets each having an opening therethrough and a microprojection located along a periphery of the opening and outwardly extending from the respective sheet; and
the sheets being positioned adjacent one another such that peripheries of the openings of sheets are generally aligned with one another and the microprojection of one of the sheets extends through the opening of the other sheet.

32. A device for piercing a body surface, comprising:
a pair of sheets each having an opening therethrough and a microprojection located along a periphery of the opening and outwardly extending from the respective sheet;
the sheets being positioned adjacent one another such that peripheries of the openings of sheets are generally aligned with one another and the microprojection of one of the sheets extends through the opening of the other sheet; and
wherein the microprojections of each of the sheets are positioned in different locations around the periphery of the openings.

33. A device for piercing a body surface, comprising:
a pair of sheets each having an opening therethrough and a microprojection located along a periphery of the opening and outwardly extending from the respective sheet;
the sheets being positioned adjacent one another such that peripheries of the openings of sheets are generally aligned with one another and the microprojection of one of the sheets extends through the opening of the other sheet; and
wherein the microprojections of the one sheet are located at one end of the openings and the microprojections of the other sheet are located at the opposite end of the openings.
